(19) United States
(12) Patent Application Publication
(10) Pub. No.: US 2010/0098797 A1
(43) Pub. Date: Apr. 22, 2010

(54) MOLD ASSEMBLY FOR MIDSOLE AND METHOD OF MANUFATURING SAME

(76) Inventors: Carrie L. Davis, Beaverton, OR (US); Paul VanDomelen, Beaverton, OR (US); David P. Jones, Beaverton, OR (US)

Correspondence Address: BANNER & WITCOFF, LTD., 28 STATE STREET, SUITE 1800, BOSTON, MA, 02109-1701, US

(21) Appl. No.: 12/252,666

(22) Filed: Oct. 16, 2008

(51) Int. Cl. B29D 30/66; B28B 17/00

(52) U.S. Cl. 425/129.2; 425/150

(57) ABSTRACT

A mold assembly includes an upper portion having an upper recess in a lower surface thereof; an insert having an upper surface configured to mate with the upper portion's lower surface; a first channel in one of the upper portion and the insert and in fluid communication with an exterior of the one of the upper portion and the insert and with the upper recess when the upper portion and the insert are in contact with one another. A lower portion has a lower recess in an upper surface thereof, the upper surface configured to mate with the insert's lower surface. A second channel in one of the lower portion and the insert, the second channel is in fluid communication with an exterior of the one of the lower portion and the insert and the lower recess when the lower portion and the insert are in contact with one another.

### FIELD OF THE INVENTION

Aspects of this invention relate generally to a mold assembly for a midsole and a method of manufacture, and, in particular, to a mold assembly for producing a midsole including portions having different characteristics such as densities.

### BACKGROUND OF THE INVENTION

Conventional articles of athletic footwear include two primary elements, an upper and a sole structure. The upper provides a covering for the foot that comfortably receives and securely positions the foot with respect to the sole structure. In addition, the upper may have a configuration that protects the foot and provides ventilation, thereby cooling the foot and removing perspiration. The sole structure is secured to a lower portion of the upper and is generally positioned between the foot and the ground. In addition to attenuating ground reaction forces, the sole structure may provide traction, control foot motions (e.g., by resisting over pronation), and impart stability, for example. Accordingly, the upper and the sole structure operate cooperatively to provide a comfortable structure that is suited for a wide variety of activities, such as walking and running.

The sole structure generally incorporates multiple layers that are conventionally referred to as an insole, a midsole, and an outsole. The insole is a thin, compressible member located within the upper and adjacent to a plantar (i.e., lower) surface of the foot to enhance footwear comfort. The midsole, which is conventionally secured to the upper along the length of the upper, forms a middle layer of the sole structure and is primarily responsible for attenuating ground reaction forces. The outsole forms the ground-contacting element of footwear and is usually fashioned from a durable, wear-resistant material that includes texturing to improve traction.

The conventional midsole is primarily formed from a resilient, polymer foam material, such as polyurethane or ethylvinylacetate, that extends throughout the length of the footwear, often by way of an injection molding process. The properties of the polymer foam material in the midsole are primarily dependent upon factors that include the dimensional configuration of the midsole and the specific characteristics of the material selected for the polymer foam, including the density of the polymer foam material. By varying these factors throughout the midsole, the relative stiffness and degree of ground reaction force attenuation may be altered to meet the specific demands of the activity for which the footwear is intended to be used. In addition to polymer foam materials, conventional midsoles may include, for example, one or more fluid-filled bladders and moderators.

It would be desirable to provide a mold assembly for a midsole having portions with different characteristics and a method of manufacturing a midsole having portions with different characteristics that reduces or overcomes some or all of the difficulties inherent in prior known devices. Particular objects and advantages will be apparent to those skilled in the art, that is, those who are knowledgeable or experienced in this field of technology, in view of the following disclosure of the invention and detailed description of certain embodiments.

### SUMMARY

The principles of the invention may be used to advantage to provide a mold assembly that can be used to form a midsole having a portion with a first characteristic, such as a density, and another portion with a second characteristic, such as a density, that is different than the first. In accordance with a first aspect, a mold assembly includes an upper portion having an upper recess in a lower surface thereof; an insert having an upper surface configured to mate with the upper portion's lower surface; a first channel in one of the upper portion and the insert and in fluid communication with an exterior of the one of the upper portion and the insert and with the upper recess when the upper portion and the insert are in contact with one another. A lower portion has a lower recess in an upper surface thereof, the upper surface configured to mate with the insert's lower surface. A second channel in one of the lower portion and the insert, the second channel is in fluid communication with an exterior of the one of the lower portion and the insert and the lower recess when the lower portion and the insert are in contact with one another

In accordance with another aspect, a mold assembly for a midsole includes an upper portion having a plurality of upper recesses formed in a lower surface thereof. An insert has an upper surface configured to mate with the lower surface of the upper portion. A first channel is formed in one of the upper portion and the insert, the first channel being in fluid communication with an exterior of the one of the upper portion and the insert and in fluid communication with each upper recess when the upper portion and the insert are in contact with one another. A lower portion has a plurality of lower recesses formed in an upper surface thereof, the upper surface being configured to mate with a lower surface of the insert. A second channel is formed in one of the lower portion and the insert, with the second channel being in fluid communication with an exterior of the one of the lower portion and the insert and in fluid communication with each lower recess when the lower portion and the insert are in contact with one another.

In accordance with a further aspect, a method of forming midsole with a mold assembly including an upper portion having an upper recess formed in a lower surface thereof; an insert having an upper surface configured to mate with the lower surface of the upper portion; a first channel formed in one of the upper portion and the insert, the first channel being in fluid communication with an exterior of the one of the upper portion and the insert, and in fluid communication with the upper recess when the upper portion and the insert are in contact with one another; a lower portion having a lower recess formed in an upper surface thereof, the upper surface configured to mate with a lower surface of the insert; a second channel formed in one of the lower portion and the insert, the second channel being in fluid communication with an exterior of the one of the lower portion and the insert, and in fluid communication with the lower recess when the lower portion and the insert are in contact with one another, includes the following steps: placing the lower surface of the upper portion in contact with the upper surface of the insert, and the lower surface of the insert in contact with the upper surface of the lower portion; injecting a first material through the first channel into the upper recess; injecting a second material through the second channel into the lower recess; separating the upper portion, the insert and the lower portion from one another; placing the lower surface of the upper portion in contact with the upper surface of the lower portion; and curing the first material in the upper recess and the second material in the lower recess so the first material and second material bond to form a midsole

Substantial advantage is achieved by providing a mold assembly for a midsole having portions with different characteristics and a method of manufacturing such a midsole. In particular, certain embodiments provide a mold assembly and method that allows production of a midsole having portions with different densities or different hardnesses.

These and additional features and advantages disclosed here will be further understood from the following detailed disclosure of certain embodiments.

### BRIEF DESCRIPTION OF THE DRAWINGS

FIG. 1 is a section view of an illustrative aspect of a mold assembly having an upper portion, a lower portion, and an insert positioned between the upper and lower portions.

FIG. 2 is a section view of the mold assembly of FIG. 1, shown with a first material injected into the upper portion and a second material injected into the lower portion.

FIG. 3 is a section view of the mold assembly of FIG. 1, shown with the insert removed and the upper and lower portions adjacent one another.

FIG. 4 is an elevation view of a midsole formed in the mold assembly of FIG. 1.

FIG. 5 is another illustrative aspect of a mold assembly having an upper portion, a central portion an insert positioned between the upper and central portions, and a lower portion.

FIG. 6 is an elevation view of a midsole formed in the mold assembly of FIG. 5.

FIG. 7 is a section view of the lower portion of FIG. 1, showing surface irregularities formed in a lower recess in the lower portion.

FIG. 8 is another illustrative aspect of a mold assembly showing a plurality of recesses in the upper and lower portions.

FIG. 9 is another illustrative aspect of a mold assembly showing a lower recess in a lower portion of the mold assembly that extends along only a portion of an upper recess in an upper portion of the mold assembly.

FIG. 10 is another illustrative aspect of a mold assembly showing an upper recess in an upper portion of the mold assembly that extends along only a portion of a lower recess in a lower portion of the mold assembly.

The figures referred to above are not drawn necessarily to scale, should be understood to provide a representation of particular embodiments of the invention, and are merely conceptual in nature and illustrative of the principles involved. Some features of the mold assembly for a midsole depicted in the drawings have been enlarged or distorted relative to others to facilitate explanation and understanding. The same reference numbers are used in the drawings for similar or identical components and features shown in various alternative embodiments. Mold assemblies for a midsole and methods of manufacture for such a midsole as disclosed herein would have configurations and components determined, in part, by the intended application and environment in which they are used.

### DETAILED DESCRIPTION OF CERTAIN PREFERRED EMBODIMENTS

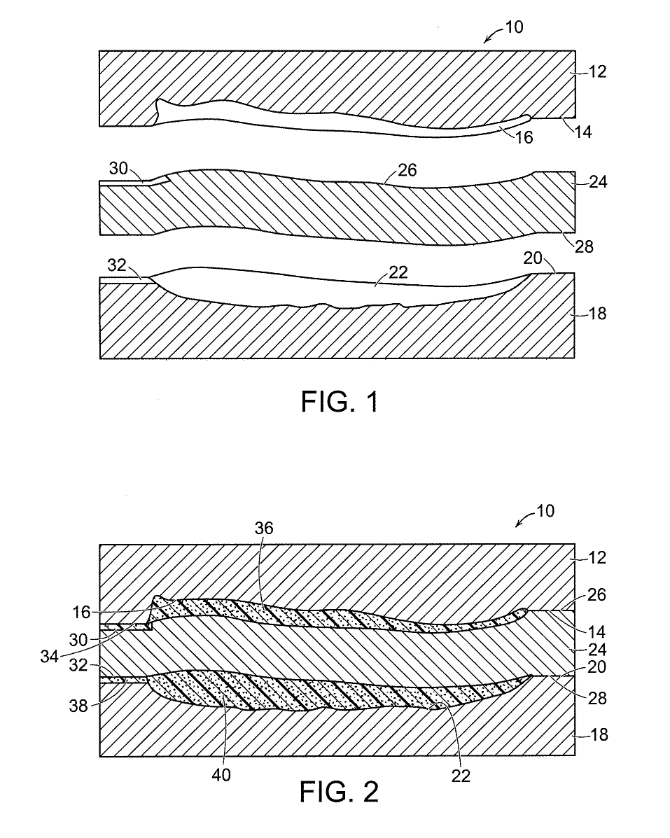

An illustrative embodiment of a mold assembly 10 for use in forming a midsole for an article of footwear is shown in FIG. 1. Mold assembly 10 includes an upper portion 12 having a lower surface 14 with an upper recess 16 formed in lower surface 14. As discussed in greater detail below, an upper portion of a midsole will be formed in upper recess 16.

A lower portion 18 of mold assembly 10 has an upper surface 20 with a lower recess 22 formed in upper surface 20. As discussed in greater detail below, a lower portion of a midsole will be formed in lower recess 22.

An insert 24 is positioned between upper portion 12 and lower portion 18. An upper surface 26 of insert 24 is shaped or configured to mate with lower surface 14 of upper portion 12. Similarly, a lower surface 28 of insert 24 is shaped or configured to mate with upper surface 20 of lower portion 18.

A first channel 30 is formed in insert 24 and extends from an exterior of insert 24 to upper surface 26 of insert 24. Thus, first channel 30 is in fluid communication with the exterior of insert 24 and upper recess 16 when insert 24 and upper portion 12 are in contact with one another.

It is to be appreciated that in certain embodiments, first channel 30 could be formed in upper portion 12, in which case first channel 30 would be in fluid communication with the exterior of upper portion 12 and upper recess 16. In either embodiment, first channel 30 is configured to allow material to be introduced from an exterior of the mold into upper recess 16.

A second channel 32 is formed in lower portion 18 and extends from an exterior of lower portion 18 to lower recess 22. Thus, second channel 32 is in fluid communication with the exterior of lower portion 18 and lower recess 22 when insert 24 and lower portion 18 are in contact with one another.

It is to be appreciated that in certain embodiments, second channel 32 could be formed in insert 24, in which case second channel 32 would be in fluid communication with the exterior of insert 24 and lower recess 22. In either embodiment, second channel 32 is configured to allow material to be introduced from an exterior of mold assembly 10 into lower recess 22.

Thus, it is to be appreciated that insert 24 could have a single channel formed therein, as illustrated here, or insert 24 could have both of first and second channels 30, 32 formed therein. In other embodiments, insert 24 could have no channels and first and second channels 30, 32 could be formed in upper portion 12 and lower portion 18, respectively.

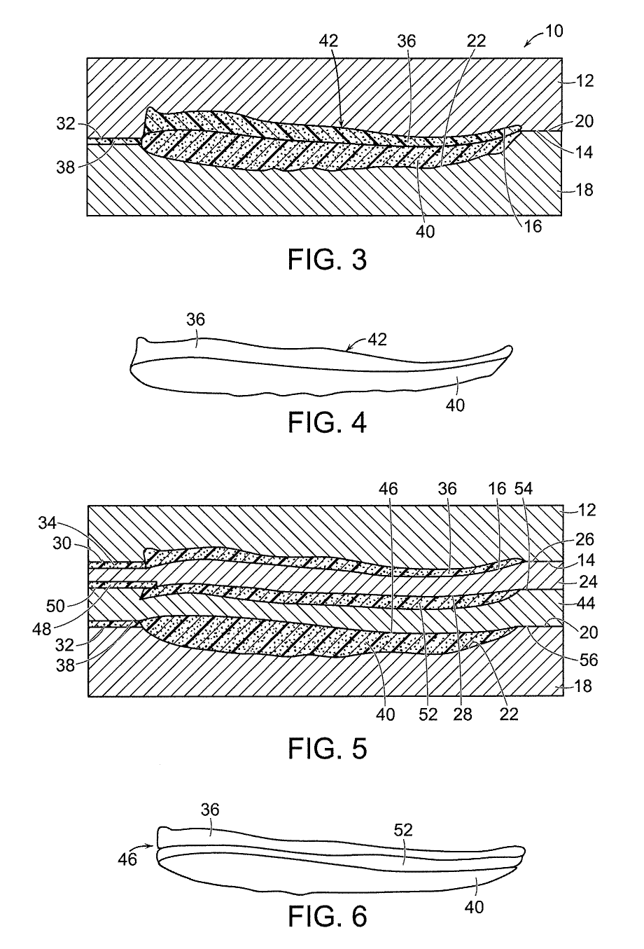

A method of forming a midsole using mold assembly 10 is illustrated in FIGS. 2-3. Upper portion 12 and insert 24 are placed into contact with one another such that lower surface 14 of upper portion 12 mates with and abuts upper surface 26 of insert 24. Similarly, lower portion 18 and insert 24 are placed into contact with one another such that lower surface 28 of insert 24 mates with and abuts upper surface 20 of lower portion 18.

A first material 34 is injected through first channel 30 into upper recess 16, thereby forming a midsole upper portion 36. Similarly, a second material 38 is injected through second channel 32 into lower recess 22, thereby forming a midsole lower portion 40.

Upper portion 12, insert 24, and lower portion 18 are then separated, insert 24 is removed, and lower surface 14 of upper portion 12 and upper surface 20 of lower portion 18 are then placed into contact with one another, as seen in FIG. 3. At this point, midsole upper portion 36 and midsole lower portion 40 are in contact with one another within mold assembly 10, thereby forming a midsole 42, seen in its entirety in FIG. 4. Midsole 42 remains in mold assembly 10 under heat and pressure for a desired amount of time to allow midsole upper portion 36 and midsole lower portion 40 to bond to one another. In certain embodiments, midsole 42 remains in mold assembly for approximately 8 minutes at a temperature of approximately 170-180° C. and a pressure of approximately 100-120 kg/cm².

Once midsole 42 is removed from mold assembly 10 it undergoes typical post cure processing steps including, for example, buffing, washing, and trimming.

In certain embodiments, first material 34 and second material 38 may have a characteristic, with the value of the characteristic of each of first and second material 34 being different than the other. Thus, in certain embodiments, second first material 34 may have a first density and second material 38 may have a second density that is different than the first density. In certain embodiments, for example, first material 34 has a first density with a specific gravity between approximately 0.15 and approximately 0.25. In certain embodiments, second material 38 has a second density with a specific gravity between approximately 0.25 and approximately 0.35.

In certain embodiments, first material 34 may have a first hardness and second material 38 may have a second hardness that is different than the first hardness. In certain embodiments, first material 34 has a first hardness between approximately 40 and approximately 45 Asker C. In certain embodiments, second material 38 has a second hardness between approximately 60 and approximately 65 Asker C.

By providing first material 34 with a different density or hardness than second material 38, midsole 42 can be modified to achieve particular performance characteristics. In certain embodiments, for example, first material 34 is less dense than second material 38 such that midsole upper portion 36 is softer than that of midsole lower portion 40 of midsole 42, thereby providing comfort for the user while at the same time providing adequate support.

First and second materials 34, 38 can be formed of any desired material. Suitable first and second materials in clued an include rubber, polyurethane foam, microcellular elastomeric foams, or phylon (Ethylene Vinyl Acetate (‘EVA’) foam). Other suitable first and second materials will become readily apparent to those skilled in the art, given the benefit of this disclosure.

Another embodiment is shown in FIG. 5 in which mold assembly 10 includes a central portion 44. Central portion 44 includes a central recess 46. A third material 48 is injected into central recess 46 through a third channel 50 to form a midsole central portion 52 of a midsole 46, seen in FIG. 6. In the illustrated embodiment, central portion 44 is positioned between insert 24 and lower portion 18 so that an upper surface 54 of central portion 44 mates with lower surface 28 of insert 24, and a lower surface 56 of central portion 44 mates with upper surface 20 of lower portion 18. It is to be appreciated that in certain embodiments central portion 44 could be positioned between upper portion 12 and insert 24, in which case upper surface 54 of central portion 44 would mate with lower surface 14 of upper portion 12, and lower surface 56 of central portion 44 would mate with upper surface 26 of insert 24.

In the illustrated embodiment, third channel 50 is formed in insert 24 and extends from an exterior of insert 24 to lower surface 28 of insert 24. Thus, third channel 50 is in fluid communication with the exterior of insert 24 and central recess 46 when insert 24 and central portion 44 are in contact with one another.

In the illustrated embodiment, first channel 30 is formed in upper portion 12, although it is to be appreciated that first channel 30 can be formed in insert 24 in this embodiment as well. Similarly, second channel 32 is formed in lower portion 18, although it is to be appreciated that second channel 32 can be formed in central portion 44 in this embodiment as well.

It is to be appreciated that in certain embodiments, third channel 50 could be formed in central portion 44, in which case third channel 50 would be in fluid communication with the exterior of central portion 44 and central recess 46. In either embodiment, third channel 50 is configured to allow a third material to be introduced from an exterior of mold assembly 10 into central recess 46.

In such an embodiment, third material 48 could have a third density or third hardness that is different than at least one of the first and second densities or first and second hardnesses. In certain embodiments, third material 48 has a third density that is different from both of the first and second densities. In certain embodiments, third material 48 has a third hardness that is different from both of the first and second hardnesses.

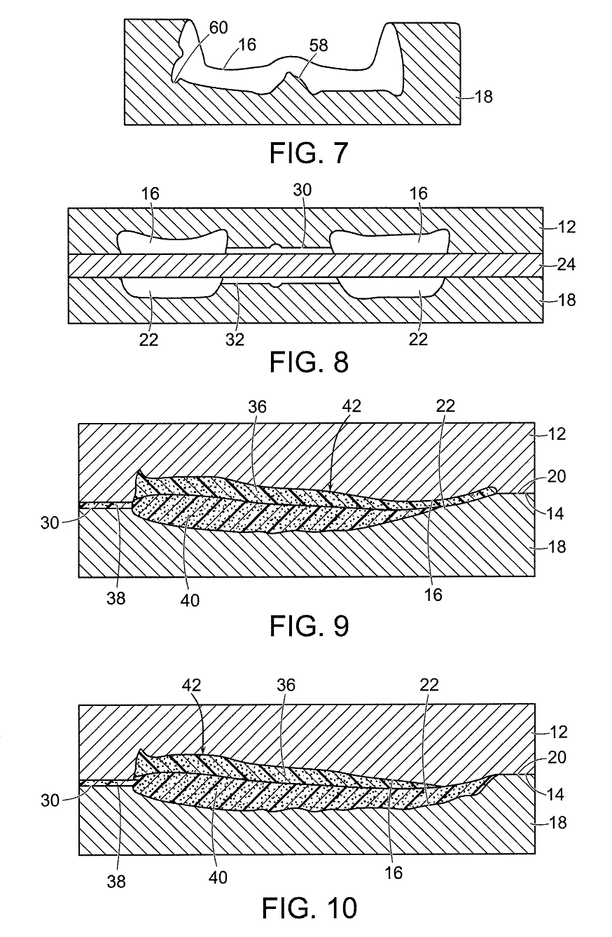

In certain embodiments, mold assembly 10 may include one or more surface irregularities that produce corresponding surface irregularities in midsole 42. As illustrated in FIG. 7, lower recess 16 is shown with at least one projection 58 that forms a corresponding recess in midsole lower portion 40. Additionally, lower recess 16 is seen here with at least one groove or recess 60 that forms a corresponding ridge or projection on midsole lower portion 40. It is to be appreciated that any portion of mold assembly 10 may include any number of surface irregularities, having any desired shape, that are configured to produce mating surface irregularities in midsole 42. Thus the surface of midsole 42 can easily be modified for performance or aesthetic benefits through the use of surface irregularities in mold assembly 10.

Another embodiment is seen in FIG. 8, in which mold assembly 10 is used to produce more than one midsole 42 during a molding process. As illustrated here, upper portion 12 includes two upper recesses 16, each of which is in fluid communication with first channel 30. Similarly, lower portion 18 includes two lower recesses 22, each of which is in fluid communication with second channel 32. It is to be appreciated that more than two midsoles 42 can be produced with a single mold assembly 10.

Another embodiment is illustrated in FIG. 9, in which lower recess 22 extends along only a portion of upper recess 16 such that when midsole 42 is formed it has two layers for only a portion of its length, with midsole lower portion 40 extending along only a portion of the length of midsole upper portion 36. In the illustrated embodiment, lower recess 22 extends from the heel portion of upper recess 16 to a metatarsal region of upper recess 16. It is to be appreciated that lower recess 22 can extend along any desired portion of upper recess 16.

In another embodiment, as illustrated in FIG. 10, upper recess 16 extends along only a portion of lower recess 22 such that when midsole 42 is formed it has two layers for only a portion of its length, with midsole upper portion 36 extending along only a portion of the length of midsole lower portion 40. In the illustrated embodiment, upper recess 16 extends from the heel portion of lower recess 22 to a metatarsal region of lower recess 22. It is to be appreciated that upper recess 16 can extend along any desired portion of lower recess 22.

Thus, while there have been shown, described, and pointed out fundamental novel features of various embodiments, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. A mold assembly for a midsole comprising:
an upper portion having an upper recess formed in a lower surface thereof;
an insert having an upper surface configured to mate with the lower surface of the upper portion;
a first channel formed in one of the upper portion and the insert, the first channel being in fluid communication with an exterior of the one of the upper portion and the insert and in fluid communication with the upper recess when the upper portion and the insert are in contact with one another;
a lower portion having a lower recess formed in an upper surface thereof, the upper surface configured to mate with a lower surface of the insert;
a second channel formed in one of the lower portion and the insert, the second channel being in fluid communication with an exterior of the one of the lower portion and the insert and in fluid communication with the lower recess when the lower portion and the insert are in contact with one another.

2. The mold assembly of claim 1, wherein the lower recess includes at least one surface irregularity to form a pattern on an exterior surface of a lower portion of a midsole formed in the lower recess.

3. The mold assembly of claim 2, wherein at least one surface irregularity comprises a projection.

4. The mold assembly of claim 2, wherein at least one surface irregularity comprises a recess.

5. The mold assembly of claim 1, wherein the upper recess extends along only a portion of a length of the lower recess.

6. The mold assembly of claim 1, wherein the lower recess extends along only a portion of a length of the upper recess.

7. The mold assembly of claim 1, further comprising at least one additional upper recess formed in the lower surface of the upper portion and at least one additional lower recess formed in the upper surface of the lower portion, the first channel being in fluid communication with each additional upper recess, and the second channel being in fluid communication with each additional lower recess.

8. The mold assembly of claim 1, further comprising;
a central portion having a central recess formed therein;
a third channel formed in one of the insert and the central portion, third channel being in fluid communication with an exterior of the one of the insert and the central portion when the insert and the central portion are in contact with one another.

9. The mold assembly of claim 8 wherein an upper surface of the central portion is configured to mate with the lower surface of the insert and a lower surface of the central portion is configured to mate with an upper surface of the lower portion.

10. A mold assembly for a midsole comprising:
an upper portion having a plurality of upper recesses formed in a lower surface thereof;
an insert having an upper surface configured to mate with the lower surface of the upper portion;
a first channel formed in one of the upper portion and the insert, the first channel being in fluid communication with an exterior of the one of the upper portion and the insert and in fluid communication with each upper recess when the upper portion and the insert are in contact with one another;
a lower portion having a plurality of lower recesses formed in an upper surface thereof, the upper surface configured to mate with a lower surface of the insert;
a second channel formed in one of the lower portion and the insert, the second channel being in fluid communication with an exterior of the one of the lower portion and the insert and in fluid communication with each lower recess when the lower portion and the insert are in contact with one another.

11. A method of forming midsole with a mold assembly comprising an upper portion having an upper recess formed in a lower surface thereof; an insert having an upper surface configured to mate with the lower surface of the upper portion; a first channel formed in one of the upper portion and the insert, the first channel being in fluid communication with an exterior of the one of the upper portion and the insert, and in fluid communication with the upper recess when the upper portion and the insert are in contact with one another; a lower portion having a lower recess formed in an upper surface thereof, the upper surface configured to mate with a lower surface of the insert; a second channel formed in one of the lower portion and the insert, the second channel being in fluid communication with an exterior of the one of the lower portion and the insert, and in fluid communication with the lower recess when the lower portion and the insert are in contact with one another, comprising the steps of:
placing the lower surface of the upper portion in contact with the upper surface of the insert, and the lower surface of the insert in contact with the upper surface of the lower portion;
injecting a first material through the first channel into the upper recess;
injecting a second material through the second channel into the lower recess;
separating the upper portion, the insert and the lower portion from one another;
placing the lower surface of the upper portion in contact with the upper surface of the lower portion; and
curing the first material in the upper recess and the second material in the lower recess so the first material and second material bond to form a midsole.

12. The method of claim 11, wherein the first material has a first density and the second material has a second density that is different than the first density.

13. The method of claim 11, wherein the first density is less than the second density.

14. The method of claim 11, wherein the first material has a first hardness and the second material has a second hardness that is different than the first hardness.

15. The method of claim 11, further including the step partially curing the first material in the upper recess and the second material in the lower recess before separating the upper portion, the insert and the lower portion from one another.

16. The method of claim 11, further comprising the step of trimming the midsole after it has cured.

17. The method of claim 11, further comprising the step of injecting a third material into a central portion positioned between the upper and lower portions.

18. The method of claim 17, wherein the third material is injected through a third channel formed in one of the insert and the central portion, third channel being in fluid communication with an exterior of the one of the insert and the central portion when the insert and the central portion are in contact with one another.

19. The method of claim 17, wherein the first material has a first density, the second material has a second density that is different than the first density, and the third material has a third density that is different from at least one of the first density and the second density.

20. The method of claim 11, wherein the step of injecting the first material includes injecting the first material into at least one additional upper recess formed in the lower surface of the upper portion.

21. The method of claim 11, wherein the step of injecting the second material includes injecting the second material into at least one additional lower recess formed in the upper surface of the lower portion.

22. The method of claim 11, wherein the lower recess includes at least one surface irregularity to form a pattern on an exterior surface of a lower portion of a midsole formed in the lower recess.

23. The method of claim 22, wherein at least one surface irregularity comprises a projection.

24. The method of claim 22, wherein at least one surface irregularity comprises a recess.
